(19) United States
(12) Patent Application Publication
(10) Pub. No.: US 2009/0183155 A1
(43) Pub. Date: Jul. 16, 2009

(54) Isolation of Content by Processes in an Application

(75) Inventors: Edward J. Praitis, Woodinville, WA (US); Shawn M. Woods, Seattle, WA (US); David M. Ruzyski, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/014,744

(22) Filed: Jan. 15, 2008

(51) Int. Cl. G06F 9/46

(52) U.S. Cl. 718/100

(57) ABSTRACT

Isolation of extension code by processes in an application is described. In an implementation, execution of one or more processes is managed that contain content received via a network by another process of a single application that includes the one or more processes. The management includes terminating the one or more processes when not responsive. Execution of the one or more processes is isolated from the other process such that when the one or more processes are not responsive the other process remains responsive. The content in the terminated one or more processes is then recovered.

### BACKGROUND

Applications may be configured to consume a wide variety of content. For example, a browser application may be configured to navigate to a wide variety of different content available via a network, such as web pages, music, online videos, and so on. This internet content is often untrusted and/or unreliable and thus its execution is to be constrained in both resource use and access control. In some instances, this content may be configured as extension code which is to extend the function of the browser application itself, which is sometimes referred to as a “plug-in”, “third-party plug-in”, “add-on”, and so forth. However, this extension code may have an adverse effect on the execution of the browser application itself, even to the point of failure. It may also attempt to perform actions the user does not want to occur.

The browser application, for instance, may receive a third-party plug-in to expand the functionality of the browser application. Because it is a “third-party” plug-in, however, it may be written according to quality standards that do not meet the standards of a writer of the browser application. For example, the plug-in may fail when executed in conjunction with the browser application. Because the plug-in is extension code that may share resources with the browser application, failure of the plug-in may cause failure of the browser application, such as to crash, “hang”, and so on.

### SUMMARY

Isolation of content by processes in an application is described. In an implementation, execution of one or more processes is managed that contain content received via a network by another process of a single application that includes the one or more processes. The management includes terminating or restarting one or more processes when not responsive, failed, or otherwise not executing properly. Execution of the one or more processes is isolated from the other process such that when the one or more processes are not responsive the other process remains responsive. The content in the terminated one or more processes is then recovered. Thus, execution of the one or more processes may be isolated from the other processes so that its client-side identity and access control may be specified and limited based on policy for the Internet content source and the user executing it. The execution of content from the Internet may then be controlled by client operating system identity and/or access control restrictions specific to the internet source and beyond that applied based on the local client user identity.

In another implementation, one or more computer-readable media includes instructions that are executable to provide a browser application having one or more tab processes and a frame process. The one or more tab processes contain content received via a network, such that each tab process isolates respective content, one from another. The frame process manages execution of the one or more tab processes. At least one of the tab processes is assigned a trust level that is lower than the frame process such that the frame process has access to one or more resources that are not available to the content contained in the at least one tab process.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an exemplary implementation that is operable to employ isolation techniques.

FIG. 2 is an illustration of an architecture showing components that may be used to form an application infrastructure.

FIG. 3 depicts an exemplary isolation infrastructure as organized into layers for a browser application.

FIG. 4 is an illustration of an exemplary implementation of a frame process and a tab process as being implemented via components of FIGS. 2 and 3.

FIG. 5 is a flow diagram depicting a procedure in an exemplary implementation in which execution of one or more processes that isolate content is managed by another processes.

### DETAILED DESCRIPTION

Overview

A variety of different applications that execute content obtained via a network may be extended by dynamically loading and executing internet-sourced content. This content may include both “hosted” and “native” code but in each case, it causes execution of instructions on the host machine. This content not only includes “internet site specific” code such as HTML but also “extension code”, which may include “plug-ins”, “add-ons”, “drivers” and so forth, that are intended to execute on various or all internet site content, or on local machine resources

The extension code is often presented as “native code” that executes without standard internet access control mechanisms or reliability control mechanisms. It may have varying degrees of quality and trustability. Further, the extension code may share resources (e.g., memory, handles, process space, and so on) with the application that hosts it. Consequently, failure of the extension code may also cause failure of the application (e.g., cause the application to “crash” or “hang”), cause inefficient consumption of resources, may result in a security breach, and so on.

Isolation of content received via a network (e.g., Internet content) by processes in an application is described. In an implementation, processes are used to isolate the execution of the internet content. For example, an internet browser application may be configured to include a frame process that is responsible for managing (and therefore is also referred to as a “manager process” in the following discussion) base functionality of the browser, such as format of functionality and controls of the browser itself, including “back” and “forward” buttons to navigate through web pages, an address bar that accepts as an input a uniform resource locator (URL) address, and so on.

The browser application may also support processes that are used to isolate (and therefore are also referred to as “isolation processes” in the following discussion) content received via the browsing from the underlying functionality of the browser application itself. These processes, for instance, may be displayed as tabs within the browser application, each being executed in a separate process. The frame process may be executed to manage the execution of the tab processes and due to the isolation, should one or more of the tab processes fail (e.g., become unresponsive), the frame process may continue to execute as intended as well as with other tab processes that did not fail. Further, the frame process may take one or more corrective actions, such as to terminate an unresponsive tab process and then recover content that was executed in the tab process. A variety of other examples are also contemplated, further discussion of which may be found in relation to the following figures.

In another implementation, the isolation techniques may be used in conjunction with a “trust judgment” to constrain access control and identity of the content. As previously described, internet-sourced content including extension code may be written with intent and to achieve goals that are not in the interests of the user or the local client. Consequently, a judgment of trust in the content may be made using, for example, knowledge of the content source or the means used to identify and/or receive the content used to assign a level of “identity and access control” to the respective content. The trust judgment may be used as a basis for access to resources of a computer that executes the extension code. Traditional techniques, however, were performed on a “per application” basis. For example, to interact with web content having different trust, multiple browser applications were executed, which do not apply client operating system access control and identify, may be resource inefficient, and may be frustrating and confusing to users from a usability standpoint. Further discussion of trust may also be found in relation to the following figures.

In the following discussion, an exemplary environment is first described that is operable to employ isolation techniques. Exemplary procedures are then described which may be employed in the exemplary environment, as well as in other environments. Although in some instances a browser application is described as employing the isolation techniques, a variety of other applications that execute internet content may also employ these techniques, such as a “gadgets” application that executes third-party extension code (e.g., in a sidebar) on a desktop of a computer to provide additional functionality, such as weather information, headlines, online videos, and so on.

Exemplary Environment

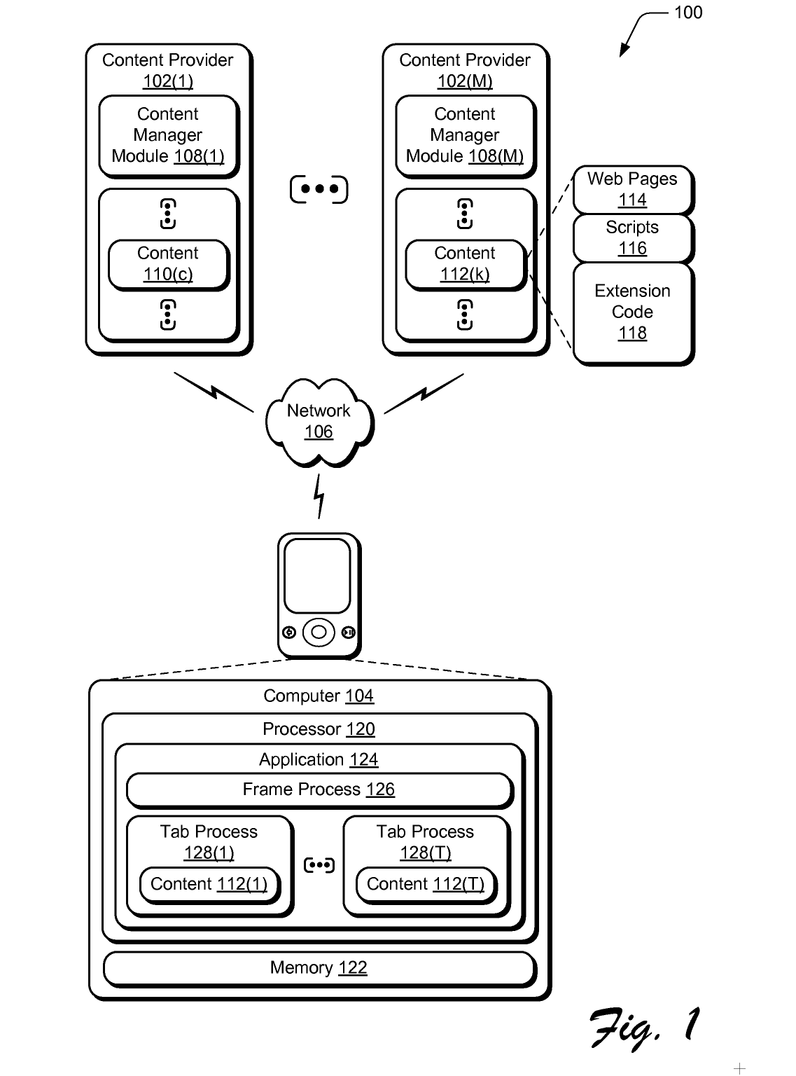

FIG. 1 is an illustration of an environment 100 in an exemplary implementation that is operable to employ isolation techniques. The illustrated environment 100 includes a plurality of content providers 102(1)-102(M) and a computer 104 that are communicatively coupled, one to another, via a network 106. The computer 104 may be configured in a variety of ways. For example, the computer 104 may be configured to communicate over the network 106, such as a desktop computer, a mobile station, an entertainment appliance, a set-top box communicatively coupled to a display device, a wireless phone, a game console, and so forth.

Although the network 106 is illustrated as the Internet, the network may assume a wide variety of configurations. For example, the network 106 may include a wide area network (WAN), a local area network (LAN), a wireless network, a public telephone network, an intranet, and so on. Further, although a single network 106 is shown, the network 106 may be configured to include multiple networks.

Each of the plurality of content providers 102(1)-102(M) are illustrated as including respective content manager modules 108(1)-108(M) that are representative of functionality to provide respective content 110(c), 112(k) (where “c” and “k” may be an integer between one and “C” and “K”, respectively) to the computer 104 over the network 106. The content may be configured in a variety of ways. For example, content 112(k) may be configured as web pages 114, scripts 116, extension code 118, and so on.

The computer 104 is illustrated as including a processor 120 and memory 122. Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Alternatively, the mechanisms of or for processors, and thus of or for a computing device, may include, but are not limited to, quantum computing, optical computing, mechanical computing (e.g., using nanotechnology), and so forth. Additionally, although a single memory 122 is shown, a wide variety of types and combinations of memory may be employed, such as random access memory (RAM), hard disk memory, removable medium memory, and other types of computer-readable media.

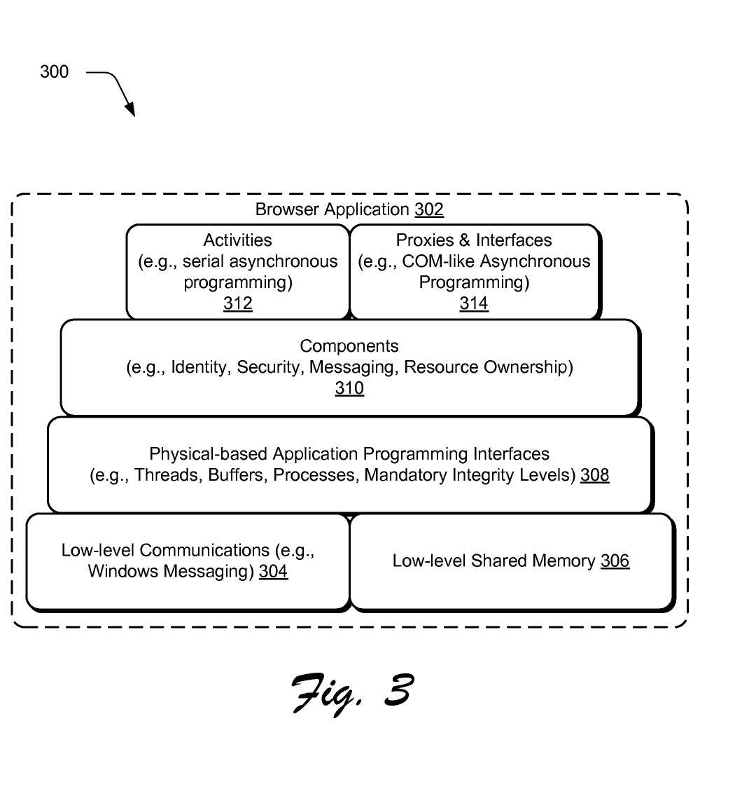

The computer is also illustrated as executing an application 124 on the processor 120, which is storable in memory 122. The application 124 may be configured to provide a wide variety of functionality, such as a browser application (further description of which may be found in relation to FIG. 3), a productivity application, and so on.

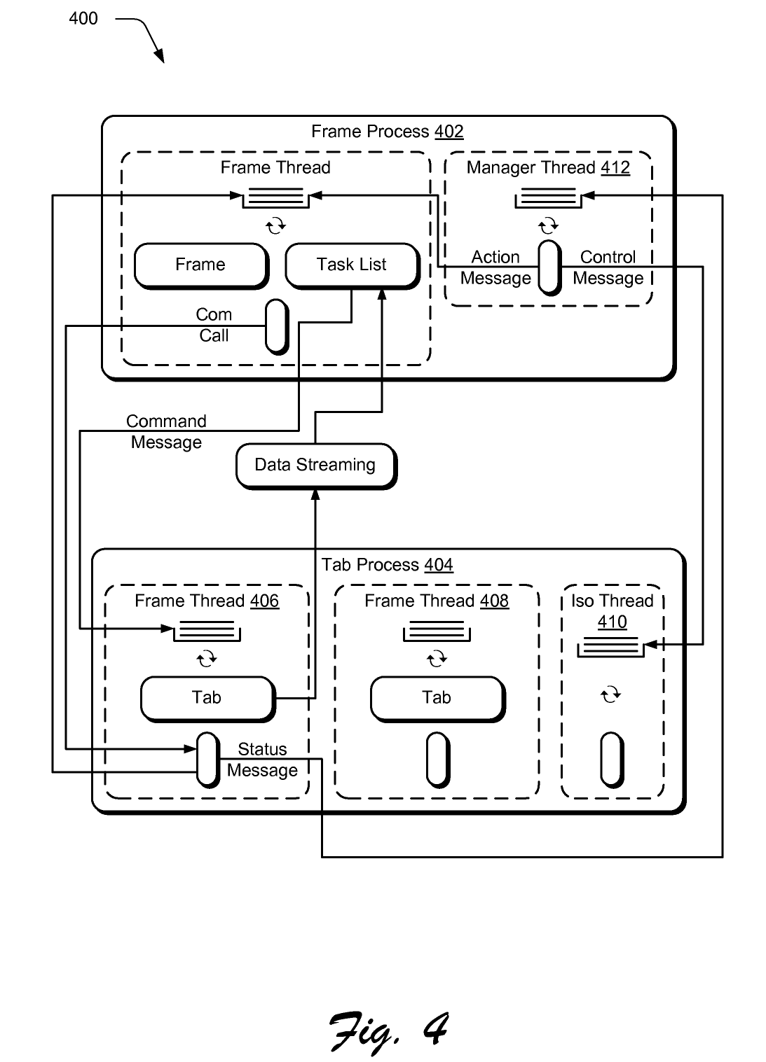

As an example, the application 124 may follow a component model and an isolation infrastructure that may use operating system primitives (e.g., a process) to isolate components, one from another through the use of manager processes and isolation processes. An example of such as isolation infrastructure is shown for application 124 that includes a frame process 126 which is an example of a manager process and a plurality of tab processes 128(1)-128(T) that are examples of isolation processes. The frame process 126 is representative of functionality to manage the tab processes 128(1)-128(T), such as to decide “where” in the computer's 104 resources (e.g., processor 120 and/or memory 122) the tab processes 128(1)-128(T) are to be executed and/or maintained, monitor the lifetimes and responsiveness of the tab processes 128(1)-128(T), terminate the tab processes 128(1)-128(T), recover respective content 112(1)-112(T) when the respective tab processes 128(1)-128(T) fail, and so on. Thus, the execution of the content 112(1)-112(T) in the respective tab processes 128(1)-128(T) does not interfere with the execution of the frame process 126, thereby maintaining responsiveness of the frame process 126 even when one or more of the tab processes 128(1)-128(T) and the included content 112(1)-112(T) becomes unresponsive, further discussion of which may be found beginning in relation to FIG. 4. In an additional implementation, this isolation achieved by the process separation further keeps content 112(1) in one tab process 128(1) from interfering with content 112(T) in another tab process 128(T) in a single application, e.g., application 124.

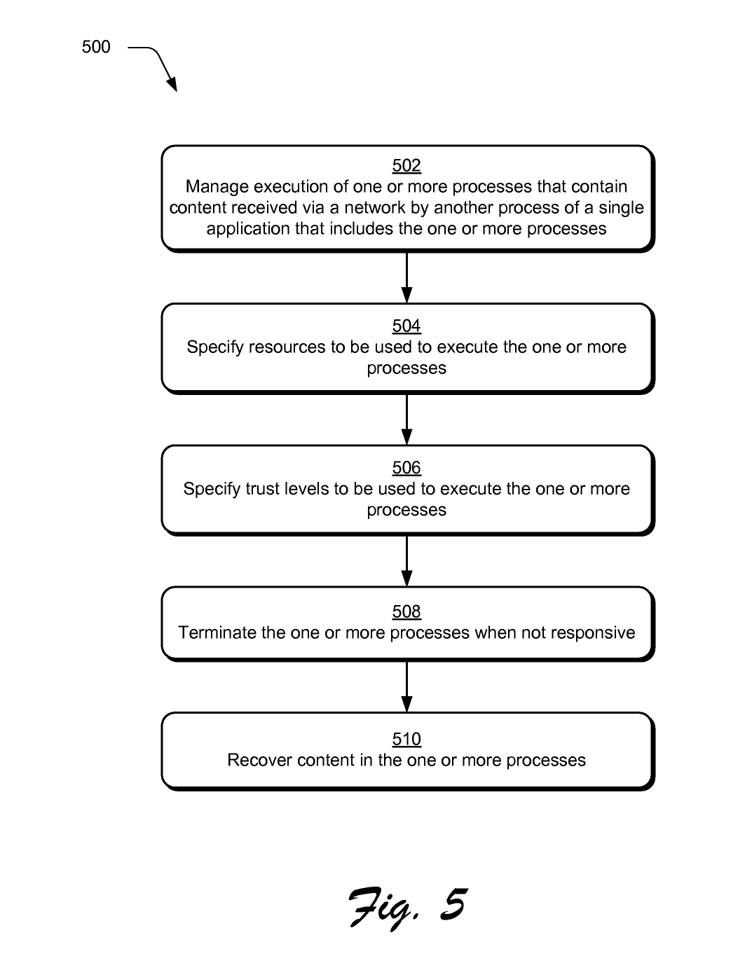

The isolation techniques, such as the isolation infrastructure, may also support a variety of other functionality. For example, the isolation of the content 112(1)-112(T) in the respective tab processes 128(1)-128(T) may enable the use of different “trust” levels by a single application. Content 112(1) executed in tab process 128(1), for instance, may be assigned a trust level that is lower than a trust level assigned to the frame process 126. Thus, the frame process 126 may be permitted to access additional resources (e.g., software such as operating system and/or hardware such as shared memory) that are not permitted to be accessed by the content 112(1) in the tab process 128(1). Likewise, the content 112(1) in the tab process 128(1) may be assigned a different trust level than the content 112(T) in the tab process 128(T), and get access to different resources within the same application 124. Further discussion of trust levels may be found in the following discussion beginning in relation to FIG. 5.

The use of processes by a single application may support a variety of other functionality. For instance, the processes may be configured to handle different amounts of “bits”, such as the frame process 126 may operate at 64 bits while one or more of the tab processes 128(1)-128(T) operate at 32 bits, the tab processes 128(1)-128(T) may operate at different bandwidths (one to another), and so on. A variety of other examples are also contemplated, further discussion of which may be found in relation to the following figures.

Generally, any of the functions described herein can be implemented using software, firmware (e.g., fixed logic circuitry), manual processing, or a combination of these implementations. The terms “module,” “functionality,” and “logic” as used herein generally represent software, firmware, or a combination of software and firmware. In the case of a software implementation, the module, functionality, or logic represents program code that performs specified tasks when executed on a processor (e.g., CPU or CPUs). The program code can be stored in one or more computer readable memory devices, e.g., the memory 122 of FIG. 1. The features of the isolation techniques described below are platform-independent, meaning that the techniques may be implemented on a variety of commercial computing platforms having a variety of processors.

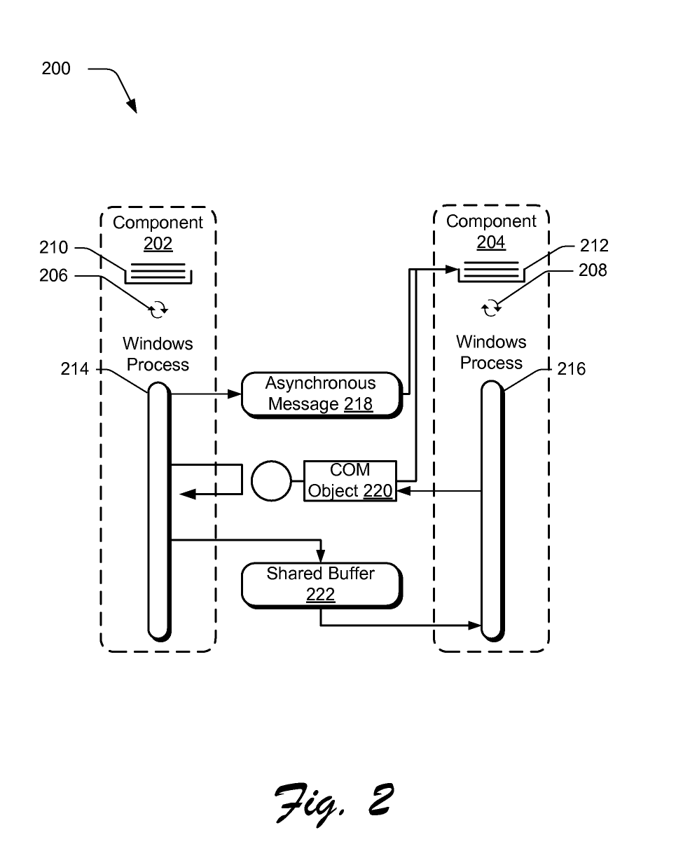

FIG. 2 depicts an architecture 200 showing components 202, 204 that may be used to form an application infrastructure. The architecture 200 may provide an isolation infrastructure (ISO), which serves as a substrate for application features. The ISO may be divided from the application code into separate subsystems that may be reused, e.g., used a plurality of times by different application features, and for testing such that the correctness, security and reliability of the ISO may be tested directly.

For example, the ISO may be architected to allow asynchronous communication. A component object model (COM), for instance, is a full-duplex mechanism and therefore does not support half-duplex communications. In another example, the ISO may support different levels of trust for artifacts, guarantee knowledge of a trust level for artifacts and provide an ability to detect that trust level. In a further example, location of artifacts may vary between in-process-in-thread, in-process/different thread, different process, different mandatory integrity level/compartment, and so on. In yet another example, ISO may allow the changing and expansion of implementation “beneath” application programming interfaces (APIs) of the ISO.

A basic unit of the architecture 200 of ISO may be thought of as a “component”, examples of which are illustrated as component 202 and component 204 of the architecture 200 of FIG. 2. A component may be thought of as a unit of location and messaging. In the illustration of FIG. 2, the components 202, 204 has WINDOWS (WINDOWS is a trademark of the Microsoft Corp., Redmond, Wash.) message loops 206, 208. The components 202, 204 are further illustrated as living “on” respective threads 210, 212 and “in” respective processes 214, 216 (e.g., a WINDOWS process). Although illustrated separately, the respective threads 210, 212 may exist “within” the respective processes 214, 216.

A variety of different types of communication may be supported between the components 202, 204. For example, the components may communicate using an asynchronous message 218 via a message loop. In another example, a cross-apartment synchronous COM (Component Object Model) call may be implemented using a COM object 220. In an implementation, the components 202, 204 may be implemented in COM apartments such that calling a COM object may enter or suspend an object. In a further example, a shared buffer 222 may be used, e.g., for streaming data. Yet other examples are also contemplated.

FIG. 3 depicts an exemplary isolation infrastructure 300 as organized into layers for a browser application 302. A “lowest” layer (e.g., abstraction wise) of the browser application 302 of FIG. 3 includes low-level communication (e.g., WINDOWS messaging) 304 and low-level shared memory 306. A next layer includes physical-based application programming interfaces (APIs), e.g., thread, buffers, processes, mandatory integrity levels (MICs), and so on 308. A next layer above that includes components, e.g., identity, security, messaging, and resource ownership 310. A top layer in the illustrated example includes activities such as serial asynchronous programming 312 as well as proxies and interfaces, e.g., “COM-like” asynchronous programming that mimics Com techniques asynchronously.

FIG. 4 is an illustration of an exemplary implementation 400 of a frame process 402 and a tab process 404 as being implemented via components of FIGS. 2 and 3. The frame process 402 and the tab process 404 may or may not correspond to the frame process and tab process of FIG. 1.

The exemplary implementation 400 of FIG. 4 is illustrative of an isolation infrastructure that separates the application of FIG. 1 into components and manages the exchange and sharing of data and control between those components. The use of the isolation infrastructure facilitates loosely coupled componentization of the application as suggested by the figure.

The tab process 404 is a content “boundary” and may be configured such that content is isolated, one from another, through the use of a plurality of tabs. Therefore, although a single tab process 404 is illustrated, a multitude of tab processes may be employed.

The tab process 404, for example, may be used to “contain” extensions to the application, such as the browser application 302 of FIG. 3. Examples of content that is “running” in the tab process 404 are illustrated as tab threads 406, 408 and an “iso” (i.e., isolation”) thread 410. Each of the threads (e.g., frame thread 406, 408 and 410) is illustrated as a component as previously described in relation to FIG. 2 and consequently includes respective WINDOWS message loops, threads and processes. The tab process 404 may run “in-process” to frames and may be run “out-of-process” to other processes. Although not illustrated, the tab process 404 may also include a manager thread that “owns” the contents of the tab process 404.

The frame process 402 includes a manager thread 406 which is representative of functionality to manage execution of the tab process 404. For example, the frame process 402, through the manager thread 412, may decide “where” the tab process 404 is to be executed, may monitor the life and responsiveness of the tab process 404 and may banish, replace and recover the tab process 404 when an error is encountered. The manager thread 406, for instance, may determine that the tab process 404 has “hanged” (e.g., caught in an infinite loop) and therefore recover the tab process 404, such as to retrieve the content that was previously executed by the tab process. In this way, the affect tab process 404 is recovered without a re-initialization of the entire application, e.g., a browser application in this example. Communication between the threads and processes may be performed as previously described in relation to FIG. 2.

Thus, in the frame process, there is one manager thread (e.g., an “authority” manager thread) that performs the management functions, such as lifetime monitoring, and so on. There are also one or more frame threads that are responsible for rendering a user interface of the frame (e.g., back button, forward button, address bar, etc) and responding to user input to the frame.

In the tab process, there is one manager thread (which is not the authority manager thread as described in the frame process) which is responsible for creating isolation components down in the tab process at the request of the frame. There are also one or more tab threads which run tab components in the tab process and are responsible for rendering the content of the tab (e.g., an HTML page) and responding to use input for the content.

Further, there may be zero or more component threads for other components which may be running in either the frame or the tab process. These are not tabs, but are isolated in the same process to gain the advantages of isolation but avoid the performance hit of spinning up a process for each of them.

Exemplary Procedure

The following discussion describes isolation techniques that may be implemented utilizing the previously described systems and devices. Aspects of each of the procedures may be implemented in hardware, firmware, or software, or a combination thereof. The procedure is shown as a set of blocks that specify operations performed by one or more devices and are not necessarily limited to the orders shown for performing the operations by the respective blocks. In portions of the following discussion, reference will be made to the exemplary environment described in relation to FIGS. 1-4.

FIG. 5 depicts a procedure 500 in an exemplary implementation in which execution of one or more processes that isolate content is managed by another process. Execution of one or more processes that contain content received via a network is managed by another process of a single application that includes the one or more processes (block 502). For example, application 124 is illustrated as including a frame process 126 and a plurality of tab processes 128(1)-128(T). The application 124, for instance, may correspond to a browser application 302 with the frame process 126 being responsible for providing a framework of controls (e.g., forward and back buttons, address bar, and so on), within which content 118(c), 112(k) received via the network 106 may be output through use of the tab processes 128(1), 128(T). Thus, a window of the browser application 302 may include a frame provided by the frame process 126 through which content 112(1)-112(T) is output through tab processes 128(1)-128(T). Although receipt of content via a network is described, content may be received in a variety of other ways, such as via a computer-readable medium.

Resources are specified to be used to execute the one or more processes (block 504). The frame process 126, for instance, may specify hardware resources (e.g., particular shared memory), software functionality (e.g., handles, handle spaces and/or handle scopes), and so on to be used by a tab process 128(1) that is initiated to isolate content 112(1) received via the network 106. A variety of other examples are also contemplated, such as to specify trust levels to be used to execute the one or more processes (block 506). The trust levels, for instance, may be determined based on a privacy policy, source of the content 112(1), certificates included with the content 112(1) (e.g., whether self-signed or from a certificate authority), and so on.

Management may also include terminating the one or more processes when not responsive (block 508). The frame process 126, for instance, may periodically poll the tab processes 128(1)-128(T). When a response is not received from one or more of the tab processes 128(1)-128(T) within a predetermined amount of time, the respective one or more of the tab processes 128(1)-128(T) may be terminated. Thus, even when one or more of the tab processes 128(1)-128(T) fails (e.g., “hangs”, is “busy”, and so on), this failure does not “spread” to the frame process 126 (e.g., and in an implementation other tab processes) such that the frame process is still responsive. Accordingly, a variety of corrective actions may be taken.

As an example, the content may be recovered in the one or more processes (block 510). For instance, the frame process 126 may determine “where” (e.g., URL) the content 112(1) was obtained in the tab process, reinitiate the tab process 128(1) that was terminated, and re-obtain the content 112(1). Thus, rather than cause a total failure of the application as was previously encountered in such an instance, the content 112(1) may be recovered automatically and without user intervention.

Conclusion

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. One or more computer-readable media comprising instructions that are executable to provide an application having:
one or more isolation processes that contain content received via an Internet to add functionality to the application; and
a manager process to manage execution of the one or more isolation processes such that performance of an undesirable action by the executed content in a respective said isolation process is isolated from and controlled by the manager process.

2. One or more computer-readable media as described in claim 1, wherein the application is a browser application to navigate through content accessible via the Internet.

3. One or more computer-readable media as described in claim 2, wherein:
the manager process is configured as a frame process that provides one or more controls that are selectable to perform the navigation; and
the one or more controls include a back button, a forward button and an address bar.

4. One or more computer-readable media as described in claim 1, wherein the content is code from a third-party that is configurable as sitespecific code or extension code.

5. One or more computer-readable media as described in claim 1, wherein the management of the execution of the one or more isolation processes by the manager process includes recovery of the executed content and its current executional context in the respective said isolation process when the respective said isolation process fails.

6. One or more computer-readable media as described in claim 1, wherein the management of the execution of the one or more isolation processes by the manager process includes determining whether the executed content in the respective said isolation process is responsive.

7. One or more computer-readable media as described in claim 6, wherein the management of the execution of the one or more isolation processes by the manager process includes when the content in the respective said isolation process is not responsive, terminating the respective said isolation process

8. One or more computer-readable media as described in claim 1, wherein execution of the manager process is provided with an identity and level of trust that is different than the one or more isolation processes such that: the manager process is provided with access to resources that are not provided to the one or more isolation processes.

9. One or more computer-readable media as described in claim 1, wherein communication between the manager process and the one or more isolation processes includes use of one or more asynchronous messages.

10. One or more computer-readable media as described in claim 1, wherein:
the one or more isolation processes include a first said isolation process and a second said isolation process; and
communication between the first and second said isolation processes includes use of one or more asynchronous messages.

11. One or more computer-readable media comprising instructions that are executable to provide a browser application having:
one or more tab processes that contain content received via a network, such that each said tab process isolates respective said content, one from another and from other parts of the client system, based on judgment of trust, intent, or reliability of said content; and
a frame process to manage execution of the one or more tab processes, wherein at least one said tab process is assigned a trust level that is lower than the frame process such that the frame process has access to one or more resources that are not available to the content contained in the at least one said tab process.

12. One or more computer-readable media as described in claim 11, wherein the judgment of trust is based at least in part on intent or reliability of said content.

13. One or more computer-readable media as described in claim 11, wherein another said tab process is assigned a trust level that is different than the at least one said tab process, such that the content of the other said tab process has access to the one or more resources that are not available to the content contained in the at least one said tab process.

14. One or more computer-readable media as described in claim 11, wherein another said tab process is assigned a trust level that is different than the at least one said tab process, such that the content of the both said tab processes do not have access to the one or more resources that are available to the content contained in the at least one said other tab process.

15. One or more computer-readable media as described in claim 11, wherein the content includes extension code from a third party that is executable to extend functionality of the browser application.

16. One or more computer-readable media as described in claim 15, wherein execution of the extension code in a respective said tab process is isolated from the frame process such that failure of the extension code in the respective said tab process does not cause failure of the frame process.

17. A method comprising:
managing execution of one or more processes that contain content received via a network by another process of a single application that includes the one or more processes by:
terminating the one or more processes when not responsive, wherein execution of the one or more processes is isolated from the other process such that when the one or more process are not responsive the other process remains responsive; and
recovering the content in the terminated one or more processes; and
controlling and limiting identity and access control of the one or more processes.

18. A method as described in claim 17, wherein the isolation of the execution of the one or more processes from the other process is performed through execution in different said processes.

19. A method as described in claim 17, wherein the isolation of the execution of the one or more processes from the other process is performed through use of one or more asynchronous messages such that failure of the one or more processes to respond to the one or more asynchronous messages of the other process do not cause failure of the other process.

20. A method as described in claim 17, wherein the content includes extension code.
